(19) United States
(12) Patent Application Publication
(10) Pub. No.: US 2011/0313822 A1
(43) Pub. Date: Dec. 22, 2011

(54) Method of Assessing Parking Fees Based Upon Vehicle Length

(76) Inventor: Joshua Burdick, New York, NY (US)

(21) Appl. No.: 13/219,845

(22) Filed: Aug. 29, 2011

Related U.S. Application Data
(63) Continuation-in-part of application No. 12/072,341, filed on Feb. 26, 2008, now Pat. No. 8,050,963.
Application No. 12/072,341 is a continuation-in-part of application No. 12/702,467, filed on Feb. 9, 2010.

(51) Int. Cl. G07B 15/02; G07B 15/00; G06Q 20/00

(52) U.S. Cl. 705/13; 235/380; 705/400; 705/418

(57) ABSTRACT

A method for assessing fees for parking is disclosed. The method includes providing vehicle length or information about a vehicle which is associated with the vehicles length to a parking meter or other fee collection device. The parking fee collection device communicates with an associated database containing a parking fee charged for vehicle based upon vehicle length. A vehicle operator enters into the parking fee collection device a vehicle length or information about the vehicle which is associated with vehicle length for a selected vehicle and a parking fee is assessed based upon the vehicle length. The database may also contain information about unpaid parking tickets associated with vehicles, a list of stolen vehicles and/or outstanding warrants for vehicle owners. An appropriate notice is provided when a match is found.

### CROSS REFERENCE TO RELATED APPLICATION

This application is a continuation in part of U.S. patent application Ser. Nos. 12/072,341 filed Feb. 26, 2008 and 12/702,467 filed Jun. 10, 2010.

### FIELD OF INVENTION

The present invention relates to the parking of vehicles and, more particularly, to calculating a parking fee for a vehicle.

### BACKGROUND OF THE INVENTION

Vehicle owners are often charged for parking their vehicle in a parking lot owned by a provider of parking services or on the side of a street owned or maintained by a municipality. For example, Japanese Patents 406325294, 407249195, 041312700 and 02002175595 disclose different parking management systems. Generally, the price, or parking fee, charged for parking in a certain area is based on the amount of time a vehicle is parked. In some cases, a flat fee is charged for parking a certain number of hours, or days, in a parking lot or space. Cities and other municipalities often provide residents a parking permit for a certain fee that permits the resident to park adjacent the side of various streets in a designated area for a year.

Parking fees are also charged by parking lot providers and collected prior to a vehicle owner removing the vehicle from the parking lot. For instance, Japanese Patent 4096325294 discloses a parking management system that can be used by a parking lot provider. The disclosed system is configured to scan the length of a vehicle and, based on the sensed length, select an appropriate free parking space suitable for the length of the vehicle and provide the owner of the vehicle printed instructions to drive to the assigned parking space to park the vehicle. A parking ticket is also provided to the owner for use in paying the fee for parking his or her vehicle. When the vehicle owner is ready to remove his or her vehicle from the parking lot, the vehicle owner pays the parking fee by inserting the parking fee ticket into a parking ticket processor. The parking fee processor calculates the parking fee based on the amount of time the vehicle was parked in the parking lot. The system is configured to permit the vehicle to exit the parking lot after the parking fee is paid.

It is common also for parking to be provided along the side of a street adjacent the curb of the street. Often, cities and other municipalities offer parking along the side of a street for a fee that is charged by a parking meter. In all of these situations, the parking fee is calculated without regard to the size of the vehicle. As a result, owners of small vehicles normally pay the same amount to park in a parking lot or on a city lot as owners of large vehicles.

In many cities a lack of parking space and traffic congestion are significant problems. If drivers have incentives to drive smaller cars, the extent and severity of these problems can be reduced. If more people drove smaller cars, more cars could be parked in many lots and along many city streets. Assessing parking fees based upon vehicle length can provide such an incentive. This may also result in an increase in parking fee revenues to the state, city or other municipality that collects parking fees.

### SUMMARY OF THE INVENTION

I provide a fair and democratic method that assesses parking fees for vehicle parking based upon the length of a vehicle in addition to the current method of charging for time only. My method includes measuring, or otherwise determining from the information about the vehicle, the length of the vehicle to determine a vehicle measurement and assessing a parking fee based upon the vehicle measurement. Preferably, the parking fee is calculated so that a longer vehicle is charged more than a shorter vehicle for parking in the selected area.

Of course, the parking fee may also be based on the amount of time the vehicle is parked. Indeed, I prefer to calculate parking fees based upon both time and vehicle length. The parking fee may be collected by a parking meter or other parking fee collector.

Embodiments of my method may also include marking at least a portion of the selected parking area in increments of length. For example, one or more portions of the selected parking area may be marked in one foot increments. In one embodiment of my method, the parking fee is calculated by multiplying a certain fee by the number of markings or other incremental length indicia the parked vehicle covers.

The selected parking area may be a parking lot, a multi-level parking lot or an area adjacent one or more sides of a street. Markings to indicate length may be on the surface on which the vehicle is parked or on a curb adjacent that surface.

In some embodiments, the parking fee is charged based on two or more length ranges. The length ranges may include a first length range that includes lengths that are shorter than lengths in the second length range. Of course, more than two length ranges may be used. The parking fee may be based on which length range the length of the vehicle falls within. For example, a vehicle with a length in the second length range may be charged a parking fee that is higher than a vehicle with a length that falls within the first length range.

The selected area may be configured to permit different vehicles to park. For example, a selected parking area may be sized for parking automobiles, cars, trucks, sport utility vehicles, scooters, all terrain vehicles, motorcycles or any combination thereof.

It should be appreciated that the length of the vehicle may be measured in various ways. In one embodiment, the length of the vehicle is measured by a measurement device that includes one or more sensors operatively connected to one or more processors configured to receive input from the one or more sensors and calculate the length of the vehicle based on the input. In some embodiments, such a measurement device is connected to a parking meter. Preferably, the one or more processors are also configured to cause the parking meter to display the calculated parking fee after receiving the input from the one or more sensors. In addition, it is my intention to have the length of the vehicle indicated on the state issued registration tag or other marking on the vehicle thereby eliminating any arbitrary determination of the vehicle's length.

In yet another embodiment the vehicle's make and model are noted on the registration card or insurance card for the vehicle. Associated parking costs are determined by a sidewalk mounted computerized meter in which the vehicle's owner inputs vehicle information, such as the vehicle's make and model, license plate number, parking permit number, insurance policy number or even an E-Z pass number. This information enables the meter to search a database which contains a vehicle length associated with the information that was entered.

Alternatively, the meter may be able to read the owner's registration card, insurance card, license plate, E-Z pass, parking permit, or parking lease card. Numbers or alpha numeric codes assigned by the vehicle registration bureau, insurance company or issuer of the E-Z pass, parking permit or parking lease could be used to identify the make and model of a vehicle in place of the words and numbers used by the manufacturer.

In yet another embodiment the parking meter communicates with a central processor and associated memory which can be at a remote location. The database may contain not only vehicle length information but also a record of unpaid parking tickets, a listing of vehicles that were reported stolen and outstanding warrants for vehicle owners. In the event a match of unpaid parking tickets is found, the meter may give notice to the vehicle owner and provide an opportunity to pay the parking ticket by credit card or debit card through the meter. If a database search reveals that the vehicle is a stolen vehicle or that there is an outstanding warrant, the central processor may notify police of the location of the vehicle.

Other details, objects, and advantages of the invention will become apparent as the following description of certain present preferred methods of practicing the invention proceeds.

### BRIEF DESCRIPTION OF THE DRAWINGS

In the accompanying drawings I have illustrated certain present preferred methods of practicing my method of assessing parking fees:

FIG. 1 is a perspective view of an embodiment of parking meters configured to collect parking fees based on the length of a vehicle.

FIG. 2 is a front view of the face of the parking meter embodiment shown in FIG. 1.

FIG. 3 is a perspective view of a second embodiment of parking meters configured to collect parking fees based on the length of a vehicle.

FIG. 4 is a flow chart illustrating a first present preferred embodiment of my method of assessing a parking fee.

FIG. 5 is a flow chart illustrating a second present preferred embodiment of my method of assessing a parking fee.

FIG. 6 is a flow chart illustrating a third present preferred embodiment of my method of assessing a parking fee.

### DETAILED DESCRIPTION OF PRESENT PREFERRED EMBODIMENTS

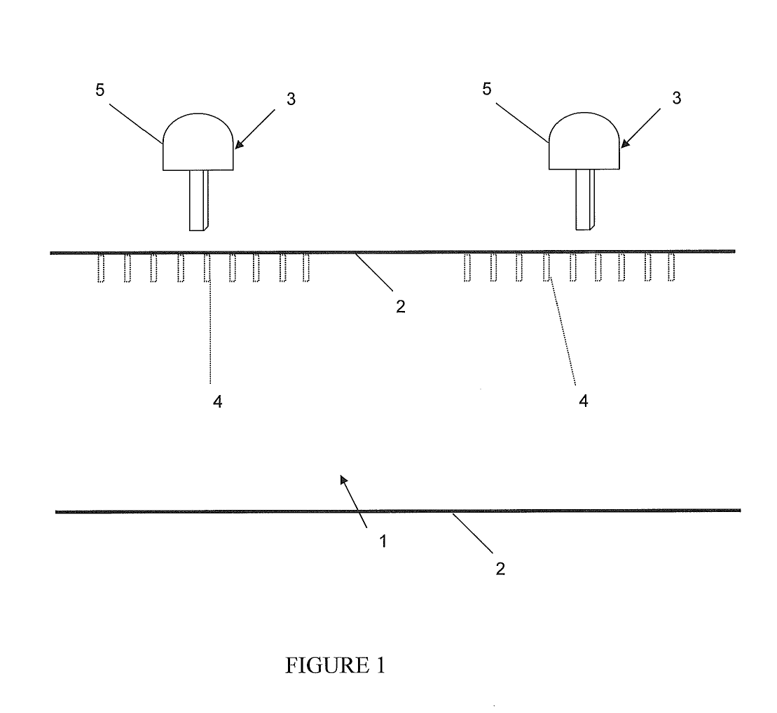

A street 1 having a selected parking area adjacent the curb 2 of the street 1 has parking meters 3 adjacent portions of the selected parking area is shown in FIG. 1. The parking meters 3 are attached to the ground adjacent the street 1. The parking meters have a head 5 that is configured to permit a vehicle owner that parks in a portion of the selected parking area to pay a parking fee.

The head 5 of the parking meter includes a face that is configured to permit a vehicle owner to pay the parking fee. The head 5 has a display 7, a parking fee collection system 11, which may include slots for receiving cash, coins, or credit card payments, and a key pad 9 or touch screen. The parking meter 5 may be configured so a vehicle owner can enter data, such as vehicle length and parking duration time in the key pad. The parking meter can also be configured to calculate a parking fee based on the input provided by the vehicle owner.

The selected parking area may be marked with markings 4 or other indicia that identify increments of length. Preferably, the markings identify one foot increments of length. The parking meter 3 can be configured to ask a vehicle owner to enter the number of increments the parked vehicle covers in display 9. The vehicle owner may respond by entering the number with key pad 9 or touch screen. Based on this input, the parking meter may calculate a flat parking fee or a parking fee that is required for a certain time segment, such as a parking fee required for every 15 minutes the vehicle owner wants to have his or her vehicle parked in the selected parking area. The vehicle owner may then pay the parking fee by placing cash in the parking fee collection portion 11 of the parking meter. The parking meter may be configured to receive only coins, or may be configured to receive paper money or credit or debit card payments or a charge to an E-Z pass account in the collection portion 11.

In some embodiments, the parking meter 3 may be configured to select a parking fee based on the length range the parked vehicle falls within. For example, a parking meter may have two or more preselected length ranges that correspond to different parking fees. A first parking fee may be charged for vehicles that have a length that falls within a first length range and a second parking fee for vehicles that fall within a second length range. The parking meters 3 may include buttons 13 or other actuators configured to identify the length range the parked vehicle falls within. The parking meter may then identify a parking fee based on the selected length range.

Embodiments of the parking meters 3 discussed above generally require a vehicle owner to identify an accurate length of the vehicle. To permit verification that an accurate length has been identified, the display 9 may be configured to identify the length of the parked vehicle and the time remaining from the parking time paid by the vehicle owner. Such a display may permit parking mangers, meter maids, or other personnel to verify that correct payment for parking has been collected.

Yet, another way to determine the length of a vehicle being parked is to provide a marking on the vehicle itself which indicates the length of the vehicle. This marking could be a tag which reports the length of the vehicle or a letter or other symbol including a bar code that corresponds to the length of the vehicle. For example, a vehicle 15 feet long may be marked with a letter A, a 22 foot vehicle marked with letter B and a 25 foot long vehicle marked with letter C. The letter or other symbol could correspond to a single length or a range of lengths. For example, any vehicle measuring 15 feet or less may be marked with “A,” vehicles greater than 15 feet but not longer than 22 feet would be marked with “B” and vehicles greater than 25 feet in length would bear a letter “C”.

The marking could be contained in a vehicle registration tag issued by the state or in a parking tag issued by a municipality or parking lot operator. The vehicle registration tag could be a registration card or license plate, insurance card or even an E-Z pass card that contains vehicle information or an identifier which enables a parking meter to retrieve vehicle information from a database. When such a tag is used, the length of the vehicle is determined by reading the tag rather than using a measurement device. One advantage of providing such a tag or marking on the vehicle is that no judgment or measuring skills are needed to determine the length of a vehicle bearing such a tag or marking. Another advantage is that the marking could be machine readable such as a bar code that is read by a bar code scanner.

In embodiments that use length ranges to determine a parking fee calculation, the display 9 on the parking meter may be configured to display the time remaining in a certain color that is calibrated to indicate a particular length range. For example, in embodiments that are configured to calculate a parking fee based on different length ranges, a vehicle identified as falling within a first length range may have a paid parking time remaining displayed in blue, a vehicle identified as falling within a second length range may have a paid parking time remaining displayed in red and a vehicle identified as falling within a third length range may have a paid parking time remaining displayed in green and vehicles that are identified as falling within other length ranges may have the paid parking time remaining displayed in other colors. Of course, other embodiments may be configured so that the display indicates the length of the parked vehicle by the entered measurement or by a symbol or other indicia that corresponds to a given length or length range.

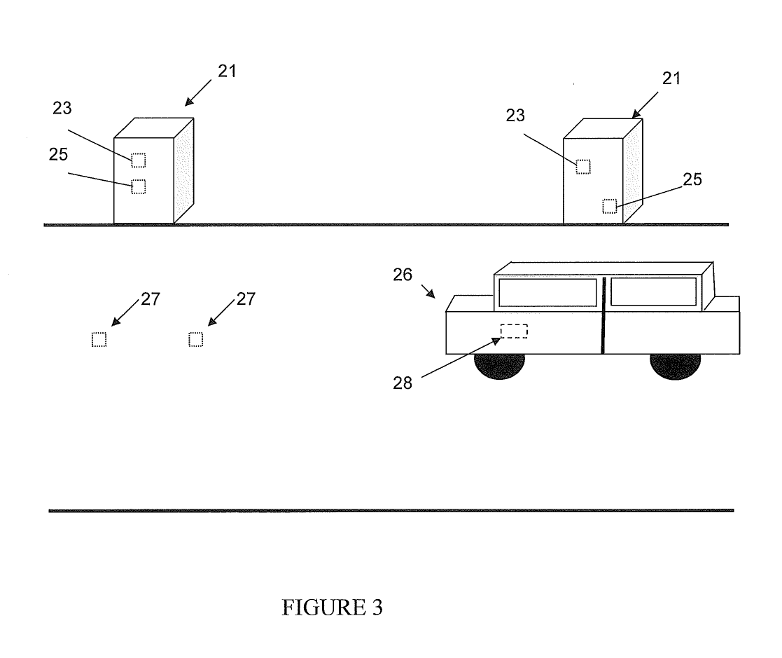

Other parking meters may be configured to sense the length of a parked vehicle so a vehicle owner or other user need not enter any length measurement input. For example, parking meters 21 shown in FIG. 3 can connect to a measuring device. The measuring device can include one or more sensors 25 and a processor 23. The sensor 25 may be configured to measure the length of a vehicle 26 parked in a selected parking area. Alternatively, the sensor may read a tag or other marking 28 on the side of the vehicle facing the parking meter which is indicated in dotted line in FIG. 3. This tag will have a marking such as a bar code which corresponds to the vehicle length and can be read by the sensor. The processor 23 is operatively connected to the sensor by wiring or other physical or wireless connection devices or connection systems. The processor 23 is configured to receive input from the sensor 25 and calculate or look up the length of the parked vehicle based on the input received from the sensor 25.

In some embodiments of parking meter 21, the processor 23 may also be operatively connected to other sensors 27 that are positioned adjacent the meter 21 and in or near the selected parking area. The sensors 27 are configured to provide input to the processor 23 so the processor can identify the length of the vehicle parked in the selected parking area based on the input received from sensors 25 and 27.

It should be appreciated that the length of a vehicle about to be parked in a parking area or that is parked in a parking area may be determined in various other ways. For example, a parking lot attendant can measure the length of a vehicle using a tape measure or preset hash marks in the pavement or marks on the side of a curb. Those marks could be painted or made with embedments. Of course, other measuring devices configured to measure length may also be used to measure the length of a vehicle.

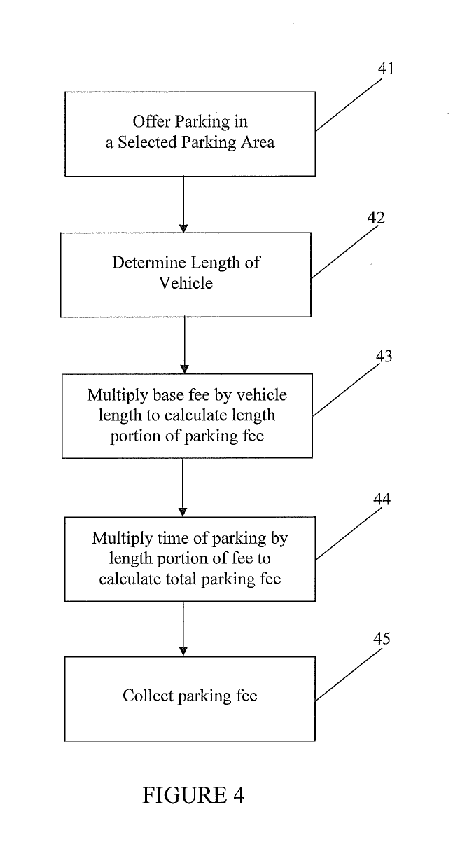

Parking meters or other devices configured to collect parking fee payments may be configured to run different programs. One such program may include the method illustrated in FIG. 4. A parking meter may be configured to offer 41 available parking in a selected area. For instance, such an offer may be made by the presence of the parking meter or by indicia or signage on or near the parking meter that indicates parking is permissible adjacent the parking meter. The length of the vehicle parked in the selected parking area may then be determined 42. The measurement of the length may be made by a vehicle owner or parking attendant who measures the length of the vehicle or relies on indicia or markings located in the parking area or by a measurement device connected to the parking meter. Such measurements are then provided to the program. The program may also be configured to multiply a base parking fee by the length of the vehicle to calculate the parking fee or to calculate 43 the length portion of the parking fee. For embodiments that calculate a length portion of the parking fee, the program may be configured to multiply 44 the length portion of the fee with a desired parking time to calculate the parking fee. Such a desired parking time may be ascertained by determining how long a vehicle has parked in the parking area. The program may then be configured to collect 45 the parking fee from the vehicle owner.

Of course, in embodiments that are configured to collect a parking fee for a certain time interval, such as every 10 minutes or every 30 minutes the vehicle is parked in the designated area, the parking meter may be configured to collect payment or prepayment for the parking of a vehicle. Once the payment of the parking fee is collected for a given time interval, such as three 10 minute segments or two 45 minute intervals, the parking meter may be configured to display indicia that indicate that the parking fee has been paid for the paid for time period. The indicia may include a time display that indicates the amount of time remaining before the collected parking fee has been spent such that an additional parking fee is required to permit the vehicle to remain parked in the designated parking area.

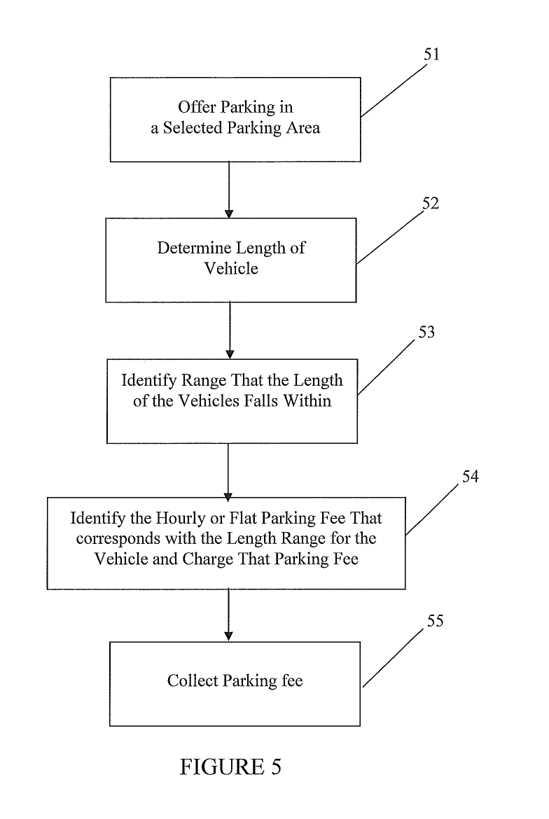

In other embodiments, a program may be configured to follow the method illustrated in the flow chart shown in FIG. 5. For instance, a parking lot may have one or more devices configured to follow the method shown in FIG. 5. The parking lot may have an attendant or signage that offers 51 parking in the parking lot or other selected parking area. The length of the vehicle to be parked in the parking area may then be determined 52 by an attendant or a sensing device. The range of lengths the vehicle falls within may then be determined 53. Once the length range is identified, the parking fee value for the length range of the vehicle may be identified 54. The attendant or a parking fee collection device may then collect 55 the parking fee.

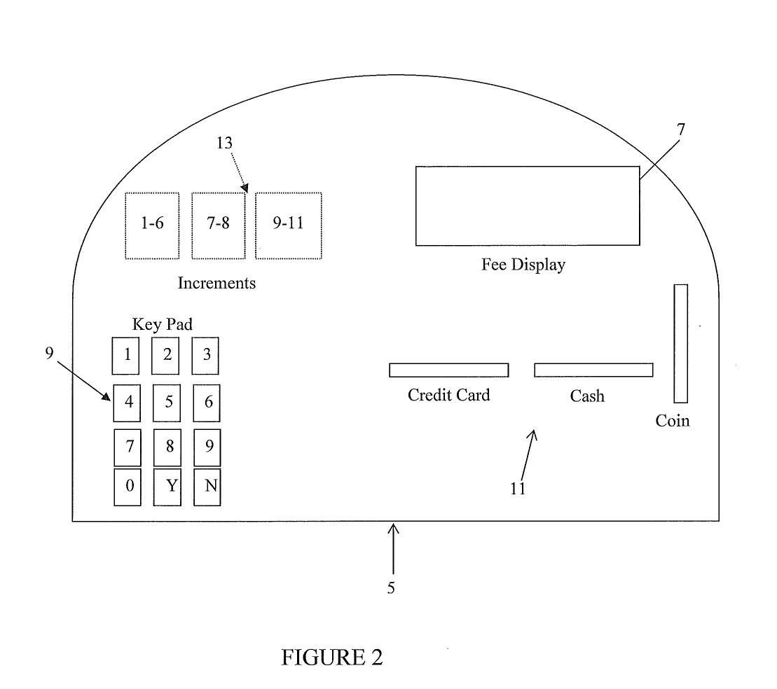

In yet another embodiment the vehicle's make and model are noted on the registration card for the vehicle. Numbers or alpha numeric codes assigned by the vehicle registration bureau could be used to identify the make and model of a vehicle in place of the words and numbers used by the manufacturer. A parking fee collection box similar to an automated teller machine or a parking meter similar to the parking meter shown in FIG. 2 has, or is connected to, a database which contains the parking fee charged for each vehicle make and model. A vehicle owner would insert his or her registration card into the parking fee collecting box or parking meter which reads the registration. This parking fee collection device has or is connected to a database of vehicle information wherein the length of a vehicle can be found. The meter or collection box may then display the hourly charge for the vehicle and receive payment. The parking fee collection device may return both the owner's registration card and a displayable ticket indicating the allowable time the vehicle is allowed to park based on the amount of time the vehicle owner has paid. In addition to, or in place of, the registration card reader the parking fee collection device may have a keypad which the vehicle owner may use to enter information from the registration card from which the parking fee is determined. A display on the meter or collection box may show the time corresponding to the amount paid. As in conventional parking meters the display may change to show the time remaining while the vehicle is in the parking space. I prefer to set up the database so that all vehicles having a same length are assessed the same parking fee. Although I identify the card containing vehicle make and model as a registration card this card could be provided by the vehicle manufacturer or dealer or some entity other than a government official or agency and this card may have a different name.

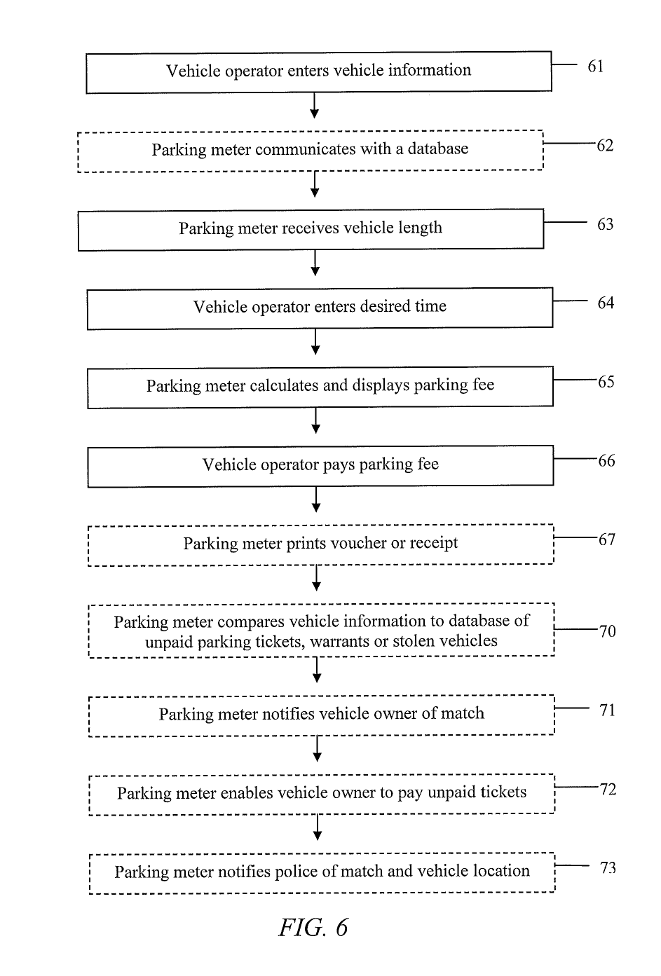

In yet another embodiment illustrated in the flow chart of FIG. 6 a vehicle operator enters the license plate number or registration number or E-Z pass number associated with the vehicle to be parked. This first step is in box 61 in FIG. 6. Next the parking meter communicates which a database which contains the length of the vehicle. This database may be in a chip in the meter or may be in a remote computer maintained by the state, the city, another municipality or a parking lot operator. This step occurs at box 62 and enables the parking meter to receive a vehicle length 63. Then at step 64 the vehicle operator enters the desire parking time. Next at box 65 the parking meter calculates and displays the parking fee to be assessed. Upon seeing the fee the vehicle operator pays the parking fee at step 66. Payment can be made using coins, a debit card, credit card or E-Z pass card at step 66. The parking meter may print out a receipt or a voucher to be placed on the vehicle dashboard at step 67. The parking meter may also or alternatively display a time remaining on the display of the parking meter.

To prevent the use counterfeit receipts and vouchers the meter may also print a bar code image on the receipt or voucher corresponding to the date and possibly the time that the receipt or voucher was issued. A meter maid could scan the bar code to determine the issue date, and, if available, the time of issue.

Another way to discourage and prevent counterfeiting of receipts and vouchers is to have the meter print a dot or dots in randomly selected colors and patterns on each receipt or voucher. Each day the selected color or colors, as well as the dot pattern, would change. One day there may be a yellow dot and a red dot. The next day there may be a green dot, a yellow dot and a blue dot. Three dots could be printed along a vertical line, along a horizontal line, along a sloped line or as points of a triangle. The meter maid would have information or would be able to get information from the meter concerning the color and pattern selected for the day. If the parked vehicle has a voucher with a different color dot or dot pattern the meter maid would know that the voucher or receipt is counterfeit and issue a parking ticket.

In yet another alternative of my method for assessing parking fees indicated by boxes 70 through 71 in FIG. 6 a processor in the parking meter or at a remote location checks the vehicle information against a list of unpaid parking tickets, list of stolen vehicles, and/or outstanding warrants. If any unpaid parking tickets are found the meter may notify the operator on a screen display and/or print out a notice that unpaid parking tickets exist. The meter may further provide an opportunity at step 72 for the vehicle operator to pay the unpaid parking ticket using a credit card or debit card.

Should a database check reveal that the vehicle has been reported as stolen or the vehicle owner has outstanding warrants, the meter may provide a notice to the police or other authorities of the location of the vehicle, as indicated in box 73.

While I have described and illustrated a parking meter that looks similar to conventional parking meters in use today, in the context of this invention parking meters are not limited to that structure. Any device which receives vehicle information, determines a parking fee based upon length of the vehicle and tells the vehicle user what parking fee is to be assessed is a parking meter in the context of this invention. The parking meter could make the determination of vehicle length and determine a parking fee alone or in combination with processors, databases and other equipment remote from the parking meter.

In describing the various embodiments of may method I describe actions taken by a vehicle operator. For purpose of this method the vehicle operator could be the driver, a passenger, a lot attendant or anyone else associated with the vehicle who provides vehicle information to the parking meter.

While it is anticipated that the present method will be used for parking automobiles, the method is applicable to all types of vehicles including trucks, sport utility vehicles, all terrain vehicles, bicycles, scooters and motorcycles. The method is also not limited to land-based vehicles and could be used for parking, or docking, boats and other watercraft.

While I have shown and described certain present preferred embodiments of my method of assessing parking fees, it is to be distinctly understood that the invention is not limited thereto but may be otherwise variously embodied and practiced within the scope of the following claims.

I claim:

1. A method for assessing a parking fee comprising:
entering vehicle information into a parking meter, the vehicle information sufficient to enable the parking meter to determine the length of a vehicle;
determining the length of the vehicle;
calculating a parking fee to be assessed based upon the length of the vehicle; and
notifying a vehicle user of the parking fee to be assessed.

2. The method of claim 1 wherein the vehicle information that is entered is vehicle license plate number, vehicle registration number, information on and insurance card, parking permit number or E-Z pass number.

3. The method of claim 1 also comprising collecting the parking fee to be assessed.

4. The method of claim 3 wherein the parking fee to be assessed is collected by receiving coins, charging a debit card, charging a credit card or charging an E-Z pass card.

5. The method of claim 3 also comprising providing a voucher to a person associated with the vehicle which indicates that the parking fee to be assessed has been paid.

6. The method of claim 1 also comprising printing a barcode, colored dot or dot pattern on the voucher which corresponds to a at least one of a date and a time of issuance.

7. The method of claim 1 also comprising the parking meter communicating with a processor and database to determine the length of the vehicle.

8. The method of claim 1 also comprising receiving the desired time from a person associated with the vehicle and calculating the parking fee based upon the time received and the length of the vehicle.

9. The method of claim 1 also comprising:
comparing the vehicle information to a database containing of least one of unpaid parking tickets associated with vehicles, warrants for vehicle owners, and stolen vehicle information; and
notifying at least one of the vehicle operator and authorities if a match is found when any comparison is made.

10. The method of claim 9 wherein a comparison finds at least one unpaid parking ticket associated with the vehicle, further comprising asking a person associated with the vehicle if that person wants to pay any unpaid parking ticket and, if so, receiving payment for the unpaid parking ticket.

11. The method of claim 9 wherein a comparison finds that the vehicle is on a list of stolen vehicles or that there is an outstanding warrant for an owner of the vehicle, further comprising notifying authorities of the result of the comparison and a location of the vehicle.

12. A method of assessing fees for parking a vehicle having a length in a selected parking area comprising:
determining the length of the vehicle to establish a vehicle measurement; and
assessing a parking fee which is based upon the vehicle measurement.

13. The method of claim 12 wherein the parking fee is also based on an amount of time the vehicle is parked.

14. The method of claim 12 further comprising marking at least a portion of the selected parking area in increments of length and using those markings to determine the length of the vehicle.

15. The method of claim 14 wherein the increments of length identify one foot increments.

16. The method of claim 12 wherein the selected parking area is comprised of at least one portion of a street and a curb adjacent the at least one portion of a street.

17. The method of claim 12 wherein the length of the vehicle is determined by a measurement device comprised of at least one sensor operatively connected to at least one processor configured to receive input from the at least one sensor and calculate the length of the vehicle based on the input.

18. The method of claim 12 wherein the selected parking area is comprised of at least one street and wherein the method of claim 1 is further comprised of marking at least a portion of the selected parking area with indicia that identify increments of length and wherein the length of the vehicle is determined based on how many indicia the vehicle covers when the vehicle is parked in at least a portion of the area for parking.

19. The method of claim 12 wherein the parking fee is charged based on at least two length ranges comprised of a first length range and a second length range, the first length range comprised of lengths that are shorter than lengths in the second length range and wherein the parking fee is based on which length range the length of the vehicle falls within.

20. The method of claim 19 further comprising providing a display that indicates which length range the length of the vehicle falls within.

21. The method of claim 20 wherein the providing of the display comprises displaying a color that is coordinated with the length range that the length of the vehicle falls within.

22. The method of claim 12 wherein the vehicle contains a marking which corresponds to the length of the vehicle and the length of the vehicle is determined by reading the marking.

23. The method of claim 12 wherein the marking is a bar code and the length of the vehicle is determined by reading the bar code.

24. The method of claim 12 further comprising collecting the parking fee.

25. The method of claim 24 wherein the parking fee is collected by a parking meter.

26. The method of claim 25 wherein the parking fee is collected after the vehicle is parked.

27. The method of claim 12 wherein the length of the vehicle is determined by a measurement device connected to a parking meter.

28. The method of claim 12 wherein the vehicle is a vehicle selected from the group consisting of automobiles, trucks, sport utility vehicles, all terrain vehicles, scooters and motorcycles.

29. The method of claim 12 wherein the parking fee is calculated so that a longer vehicle is charged more than a shorter vehicle for parking in the selected parking area.

30. A method of assessing a parking fee comprising:
providing an area for parking, the area for parking sized and configured to permit a selected vehicle from a group of vehicles of different lengths to park in the are for parking, the selected vehicle having a length;
determining the length of the selected vehicle; and
charging a parking fee for the selected vehicle that is based on the length of the selected vehicle such that a longer vehicle selected from the group of vehicles is charged more than a shorter vehicle selected from the group of vehicles for parking in the area for parking.

31. The method of claim 29 wherein the parking fee is based on at least two length ranges comprised of a first length range and a second length range, the first length range comprised of lengths that are shorter than lengths in the second length range and wherein the parking fee is based on which length range the length of the selected vehicle falls within.
